(19) United States
(12) Patent Application Publication
(10) Pub. No.: US 2025/0379429 A1
(43) Pub. Date: Dec. 11, 2025

(54) ISOLATING LINK WITH LATCH

(71) Applicant: Utility Solutions, Inc., Hickory, NC (US)

(72) Inventors: Benjamin D. Houston, Hickory, NC (US); Thomas Beane, Hudson, NC (US); Peter Shirilla, Hickory, NC (US); Eugene H. Wood, Hickory, NC (US)

(21) Appl. No.: 18/739,435

(22) Filed: Jun. 11, 2024

(51) Int. Cl. H02G 1/04

(52) U.S. Cl. CPC H02G 1/04

(57) ABSTRACT

An isolating link is disclosed. The isolating link includes an insulating rod having a first end and an opposing second end; a hook connected to the first end of the insulating rod; and a latch rotatably connected between the hook and the first end of the insulating rod, the latch adapted to rotate between an open position and a closed position and includes a rib to engage a notch positioned in the first end of the insulating rod when the latch is in the closed position.

### BACKGROUND OF THE INVENTION

This invention relates generally to electrical utility tools, and more particularly to an isolating link such as a strap hoist isolating link for use by utility workers.

Utility workers frequently carry out installation, maintenance, or repair on electrical transmission or distribution lines (conductors) mounted above ground level (i.e., "overhead wires"). Part of this work involves hanging and tensioning new distribution lines, applying proper tension to existing distribution lines, and moving distribution lines out of the way to enable access to the distribution line being worked.

Isolating links are used to provide additional protection from primary voltages when used with strap hoists, hotsticks, etc. One of the problems with current isolating links is that the latch mechanisms used in isolating links require a user to lift and rotate the latch to move the latch from an open position to a closed position. This can be difficult to do with a hotstick when the isolating link is positioned above ground. Thus, there is a need for an isolating link with a latch that can be easily closed by a hotstick or other implement when in an elevated position above ground.

### BRIEF SUMMARY OF THE INVENTION

This problem is addressed by an isolating link having a latch that is moved from the open position to the closed position without lifting the latch.

According to an aspect of the invention, an isolating link includes an insulating rod having a first end and an opposing second end; a hook connected to the first end of the insulating rod; and a latch rotatably connected between the hook and the first end of the insulating rod, the latch adapted to rotate between an open position and a closed position and includes a rib to engage a notch positioned in the first end of the insulating rod when the latch is in the closed position.

According to another aspect of the invention, an isolating link includes an insulating rod having a first end and an opposing second end; a hook connected to the first end of the insulating rod; and a latch rotatably connected between the hook and the first end of the insulating rod, the latch adapted to rotate between an open position and a closed position. The latch includes a latch base; a latch post connected to the latch base and adapted to engage a distal end of the hook; and a rib positioned on a bottom of the latch base to engage a notch positioned in the first end of the insulating rod when the latch is in the closed position.

### BRIEF DESCRIPTION OF THE DRAWINGS

The invention may be best understood by reference to the following description taken in conjunction with the accompanying drawing figures, in which:

FIG. 1 is a perspective view of an exemplary isolating link, in a closed position;

FIG. 2 is a side view of the isolating link of FIG. 1, in a closed position;

FIG. 3 is a perspective view of a hook and latch of the isolating link of FIG. 1, in a closed position;

FIG. 4 is a top view of the isolating link of FIG. 1;

FIG. 5 is an exploded view of the isolating link of FIG. 1;

FIG. 6 is a perspective view of the isolating link of FIG. 1, in an open position; and

FIG. 7 is a front view of the isolating link of FIG. 1, in an open position.

### DETAILED DESCRIPTION OF THE INVENTION

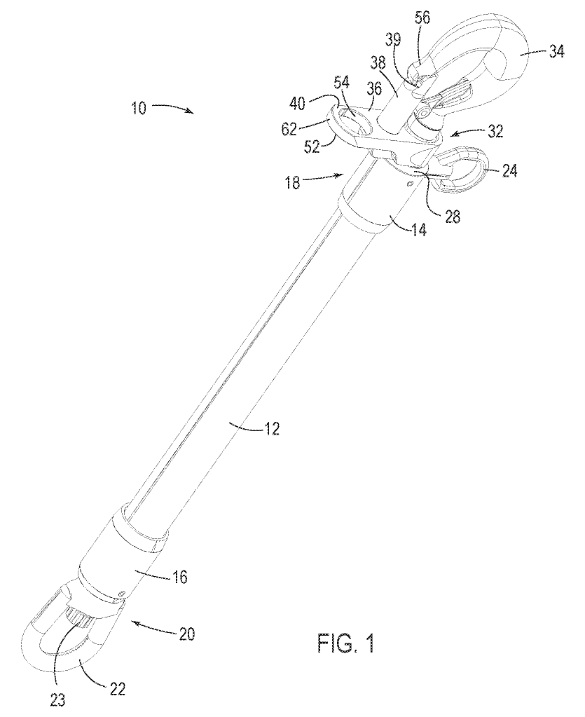

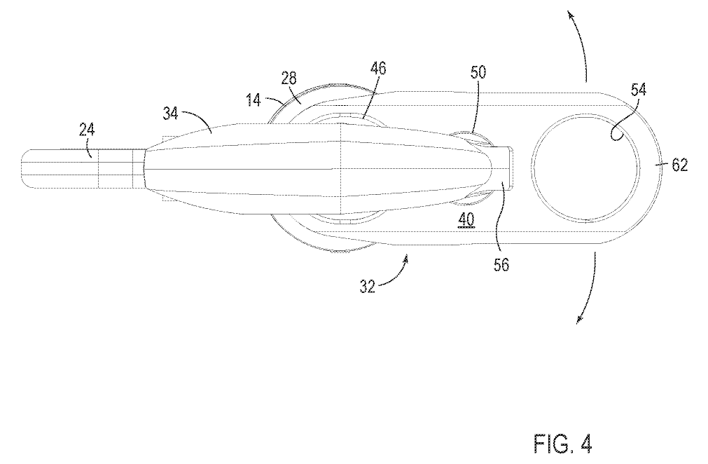

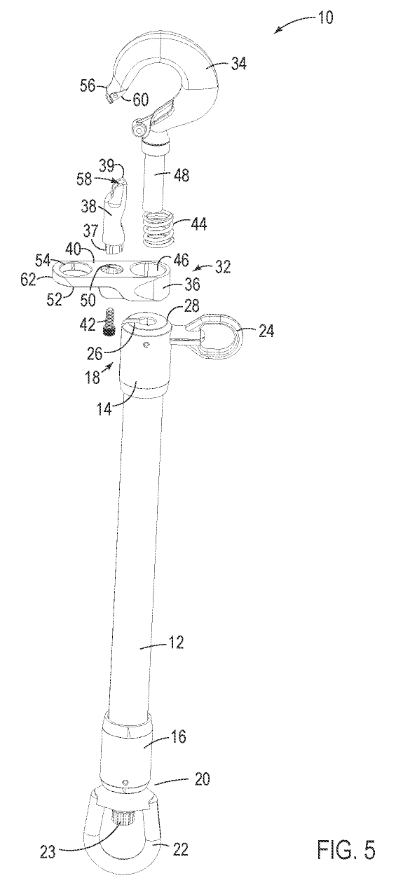

Referring to the drawings wherein identical reference numerals denote the same elements throughout the various views, FIGS. 1-7 illustrate an exemplary isolating link 10. Isolating link 10 includes an insulating rod 12 having first and second end caps 14 and 16 connected to first and second ends 18 and 20, respectively. The first and second end caps 14,16 may be connected to the first and second ends 18, 20 by any suitable means, for example, a threaded connection, a glued connection, and/or a pinned connection. An eyelet 22 is connected to the insulating rod 12 at the second end 20. As shown, the eyelet 22 is connected to the insulated rod 12 by a threaded fastener 23 that extends through the second end cap 16 and into the insulating rod 12. It should be appreciated that other suitable connection methods may be used.

The first end cap 14 includes a hotstick ring 24 to allow a hotstick or other implement to connect thereto and move the isolating link 10 to and from a use position. The first end cap 14 further includes a notch 26 cut and/or formed into a top surface 28 of the first end cap 14 to receive a projection and/or rib 30 of a latch 32 rotatably secured between the first end cap 14 and a hook 34.

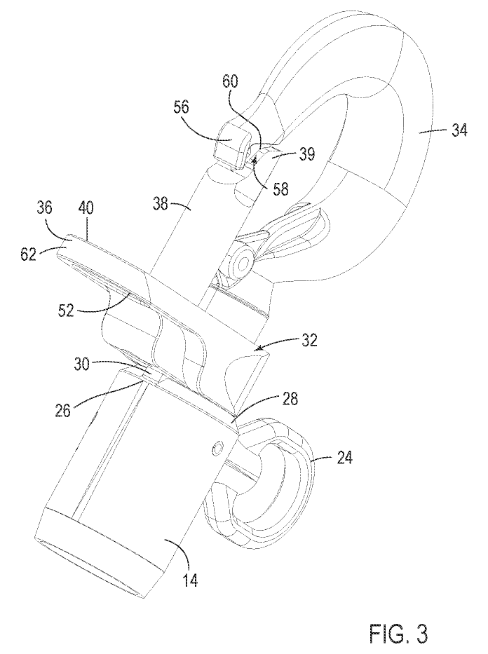

As shown in FIGS. 3-5, the latch 32 includes a latch base 36, a latch post 38 secured to a top 40 of the latch base 32 by a fastener 42, and a spring 44. It should be appreciated that other alternative means for securing the latch post 38 to the latch base 36 may be employed. For example, the latch post 38 may be secured to the latch base 36 by gluing, welding, and/or pinning the latch post 38 to the latch base 36. Further, it should be appreciated that the latch post 38 may be integrally formed with the latch base 36.

The latch base 36 includes a first aperture 46 for receiving a shank 48 of the hook 34 therethrough and for containing the spring 44 therein. As shown, the spring 44 is contained in the aperture 46 and the shank 48 extends through the spring 44 and through the aperture 46 and into the insulating rod 12 to secure the hook 34 thereto. It should be appreciated that the shank 44 may be connected to the insulating rod 12 by a threaded connection, a glued connection, and/or pinned connection. A second aperture 50 receives a first end 37 of the latch post 38 therein and allows the fastener 42 to extend through a bottom 52 of the latch base 36 and into the first end 37 to secure the latch post 38 therein. A third aperture 54 permits a hotstick or other implement to grab the latch base 36 and rotate it with respect to the hook 34. The projection and/or rib 30 is positioned on the bottom 52 of the latch base for engagement with the notch 26 positioned on the first end cap 14.

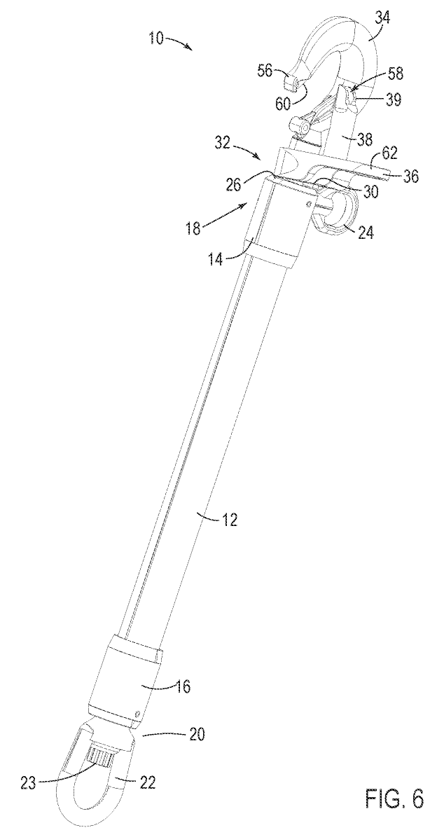

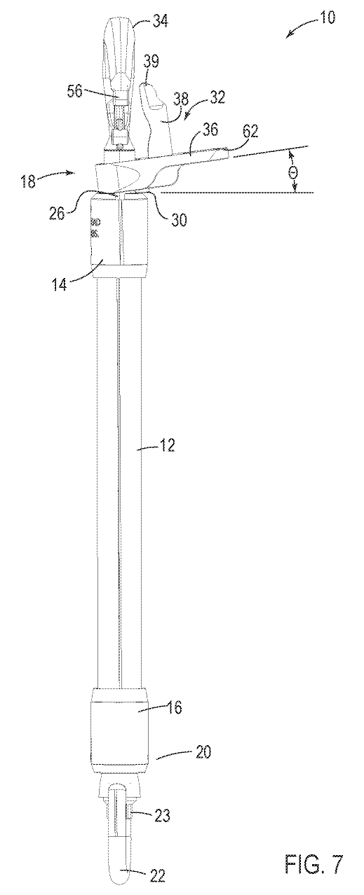

As illustrated, the latch 32 is rotatably connected to the first end 18 between the first end cap 14 and the hook 34 to allow the latch 32 to rotate from a closed position, FIGS. 1-3, to an open position, FIGS. 6-7. As shown in FIG. 7, when the latch 32 is moved to the open position, the latch 32 resides at an angle ɵ with respect to top surface 28. This angle ɵ is created by the rib 30 resting on the top surface 28 when the latch 32 is rotated to the open position. First aperture 46 is sized to permit a radial clearance between the shank 48 and the first aperture 46 to allow the latch 32 to pivot or move upwardly and reside at angle ɵ.

Spring 44 biases the latch 32 against the first end cap 14 such that when in the closed position, the rib 30 is pushed into notch 26 to maintain the latch 32 closed and prevent rotation thereof. As shown, when in the closed position, a second end 39 of the latch post 38 engages a distal end 56 of the hook 34. The second end 39 of the latch post 38 and the distal end 56 of the hook include mating surfaces to provide a secure fit in the closed position. More specifically, the second end 29 of the latch post 38 includes a concave or U-shaped groove 58 for receiving a projection or blade 60 of the distal end 56 therein.

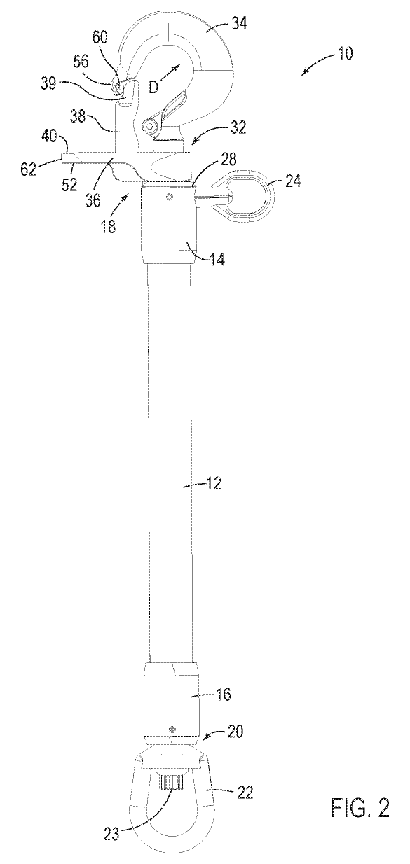

In use, a user moves the latch 32 from the closed position to the open position. This is done by pushing or lifting a distal end 62 of the latch base 36 upward (i.e. toward the hook 34 and away from the eyelet 22) to disengage the rib 30 from the notch 26 and the groove 58 from the blade 60. As shown in FIG. 2, as the distal end 62 of the latch base 36 is lifted, the latch post 38 moves back and up (shown by arrow "D") to disengage the groove 58 from the blade 60. Once the rib 30 is disengaged from the notch 26, the latch 32 is rotated to the open position, FIG. 6. The spring 44 biases the latch base 36 against the top surface 28 of the first end cap 14 such that the rib 30 rests thereon and maintains the latch 32 in the open position. A hotstick or other implement is then connected to the hotstick ring 24 to lift or move the isolating link 10 into a working position and the hook 34 is hooked onto a winch, cable, or other item.

Once the isolating link 10 is in the working position and the hook 34 is hooked, the hotstick is removed from the hotstick ring 24. The hotstick is then used to rotate the latch base 36 from the open position towards the closed position until the rib 30 snaps into the notch 26 and the groove 58 receives the blade 60 therein. This is done by pushing along a side of the latch base 36 or by engaging aperture 54 to rotate the latch base 36. The isolating link 10 is now secured onto the item and a user may pull and/or push on the isolating link 10 to move the item without fear of the isolating link disengaging the item. The pulling and/or pushing may be accomplished by attaching a hotstick, strap, rope, or other implement to the eyelet 22. It should be appreciated that movement of the latch 32 from the open position to the closed position does not require lifting of the latch base 36; rather, it is a rotation of the latch base 36 only.

To remove the isolating link 10 from the item being hooked, a user uses a hotstick to engage aperture 54 and pushes distal end 62 of the latch base 36 up toward the hook 34 and then rotates the latch base 36 to the open position.

The isolating link 10 described herein has advantages over prior art. It allows a user to move the latch 36 to the closed position easily without fear of disengaging the hook 34 from the item being hooked by eliminating the lifting of the latch 32.

The foregoing has described an isolating link. All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends any novel one, or any novel combination, of the features disclosed in this specification (including any accompanying claims, abstract and drawings), or to any novel one, or any novel combination, of the steps of any method or process so disclosed.

We claim:

1. An isolating link, comprising:
an insulating rod having a first end and an opposing second end;
a hook connected to the first end of the insulating rod; and
a latch rotatably connected between the hook and the first end of the insulating rod, the latch adapted to rotate between an open position and a closed position and including a rib to engage a notch positioned in the first end of the insulating rod when the latch is in the closed position.

2. The isolating link according to claim 1, further including an eyelet connected to the second end of the insulating rod.

3. The isolating link according to claim 1, further including a first end cap positioned on the first end of the insulating rod.

4. The isolating link according to claim 3, wherein the notch is formed in the first end cap.

5. The isolating link according to claim 3, wherein the first end cap further includes a ring adapted to receive a hot stick.

6. The isolating link according to claim 1, further including a second end cap positioned on the second end of the insulating rod.

7. The isolating link according to claim 1, wherein the latch includes a latch base and a latch post connected to the latch base, the latch post extending upwardly from a top surface of the latch base towards the hook.

8. The isolating link according to claim 7, wherein the latch base includes a first aperture configured to receive a shank of the hook therethrough for connection to the first end of the insulating rod.

9. The isolating link according to claim 8, wherein a spring is positioned in the first aperture, the spring biasing the latch base against the first end of the insulating rod such that the rib is pushed into the notch when in the closed position.

10. The isolating link according to claim 1, wherein the latch includes a latch post for engaging a distal end of the hook in the closed position, the latch post including a groove for mating with the distal end of the hook.

11. An isolating link, comprising:
an insulating rod having a first end and an opposing second end;
a hook connected to the first end of the insulating rod; and
a latch rotatably connected between the hook and the first end of the insulating rod, the latch adapted to rotate between an open position and a closed position and including:
a latch base;
a latch post connected to the latch base and adapted to engage a distal end of the hook; and
a rib positioned on a bottom of the latch base to engage a notch positioned in the first end of the insulating rod when the latch is in the closed position.

12. The isolating link according to claim 11, further including an eyelet connected to the second end of the insulating rod.

13. The isolating link according to claim 11, further including a first end cap positioned on the first end of the insulating rod.

14. The isolating link according to claim 13, wherein the notch is formed in the first end cap.

15. The isolating link according to claim 11, further including a second end cap positioned on the second end of the insulating rod.

16. The isolating link according to claim 11, wherein the latch base includes an aperture extending therethrough, the aperture receiving a spring therein and a shank of the hook, such that the shank extends through the spring and the aperture to connect to the first end of the insulating rod and rotatably connect the latch between the hook and the insulating rod.

17. A method of using the isolating link of claim 1, comprising the steps of:
moving the latch to an open position;
hooking the hook onto an item; and
rotating the latch to the closed position to secure the hook around the item.

18. The method according to claim 17, wherein the step of moving the latch to the open position includes the steps of:
moving the latch upwardly away from the second end and towards the hook; and
rotating the latch from the closed position to the open position to disengage the latch from a distal end of the hook.

19. The method according to claim 17, wherein the step of moving the latch to the closed position includes the step of using a hotstick to engage an aperture of the latch and rotating the latch to the closed position.
